(19) United States
(12) Patent Application Publication
(10) Pub. No.: US 2023/0363579 A1
(43) Pub. Date: Nov. 16, 2023

(54) BEVERAGE PREPARATION MACHINE WITH CONTROL BASED ON DEFORMATION OF AN EXTRACTION HEAD FRAME STRUCTURE AND METHOD TO CONTROL THE MACHINE BASED ON SAID DEFORMATION

(71) Applicant: SOCIETE DES PRODUITS NESTLE S.A., Vevey (CH)

(72) Inventor: JOHN PATRICK CAVANAGH, Lausanne (CH)

(21) Appl. No.: 18/245,047

(22) PCT Filed: Sep. 13, 2021
(86) PCT No.: PCT/EP2021/075074

§ 371 Date: Mar. 13, 2023

(30) Foreign Application Priority Data
Sep. 15, 2020 (EP) 20196115.8

(51) Int. Cl. A47J 31/52; A47J 31/36; A47J 31/44

(52) U.S. Cl. CPC A47J 31/525; A47J 31/3695; A47J 31/4403

(57) ABSTRACT

The invention concerns a beverage preparation machine (1) for preparing a beverage from a food substance contained in a capsule (13). The brewing chamber (35) comprises two chamber portions (34a, 34b, 12) relatively movable each other, means (7) being provided to apply a clamping force to said chamber portions in order to close the brewing chamber, the clamping means and at least part of the chamber portions (34a, 34b, 12) being connected to a frame structure (33) of the machine. A machine control unit (17) is also provided. The machine (1) comprises at least one sensor means (50) for sensing the deformations of at least a resilient deformable portion. The sensor means is connected to the control unit and, based on the sensed deformation of said deformable portion, carries out at least one of the following operation: controlling of a machine switching-on, a clamping means closure, a capsule presence in the brewing chamber, a fluid injection in the brewing chamber, a fluid temperature, detecting of the type of ingredient capsule amongst a set of different capsule types. Also a method to control a beverage preparation machine on the basis of the deformation of said resilient deformable portion is claimed.

### FIELD OF THE INVENTION

The present invention concerns a food or beverage preparation machine, in particular a home appliance. It relates more particularly to a beverage preparation machine such as liquid food preparation machine, for example a coffee preparation machine using any pre-portioned beverage ingredient within an enclosing packaging or capsule. Such machines allow a consumer to prepare at home a given type of beverage, for instance a coffee-based beverage, e.g. an espresso.

Although the invention is hereafter generally described with reference to the example of a coffee machine using capsules, it should be understood that the invention relates to any beverage preparation machine. In particular, a “beverage” is meant to include any liquid food, such as tea, coffee, hot or cold chocolate, milk, soup, baby food or the like obtained by a corresponding pre-portioned “ingredient(s)” contained within the capsule.

A “capsule” is meant to include any pre-portioned beverage ingredient within the enclosing packaging of any material, in particular airtight packaging, e.g. plastic, aluminium, recyclable and/or bio-degradable packaging, and of any shape and structure, including soft pods or pads, or sachets or rigid cartridges containing an ingredient.

### BACKGROUND OF THE INVENTION

The above cited beverage preparation machines use capsules containing ingredients (e.g. ground coffee) to be extracted or to be dissolved.

Said capsules are generally employed along with a beverage machine adapted for their use. Such machines are generally provided with means for storing and conditioning (usually heating, but also chilling) a liquid, usually water, introducing the conditioned (e.g. heated) fluid (preferably water) into the capsule to create a beverage, and dispensing the beverage into a container for consumption. The capsule is located in a brewing chamber of a machine extraction head of the machine (or simply “machine head”) from which the beverage is released.

The beverage may be prepared by inserting a capsule into the beverage machine head. The machine extraction head comprises a receptacle or cavity (the “brewing chamber”) for accommodating said capsule and a fluid injection system for injecting the fluid, e.g. water, under pressure into the capsule. Water injected under pressure in the capsule, for example for the preparation of a coffee beverage, is usually hot, that is to say at a temperature above 70° C. However, in some particular instances, it might also be at ambient temperature, or even chilled. The pressure inside the brewing chamber during extraction and/or dissolution of the capsule contents is typically about 1 to about 8 bar for dissolution products and about 2 to about 12 bar for extraction of roast and ground coffee.

In some embodiments, the brewing chamber is partly defined by a capsule receptacle which is usually called “capsule holder”. A capsule holder for holding a capsule is intended to be inserted in and completely removed from a corresponding cavity of the machine. When a capsule holder is loaded with a capsule and inserted within the machine in a functional manner, the water injection means of the machine can form a fluid connection with the capsule to inject water therein for food or beverage preparation.

In other embodiments, the brewing chamber is defined by two portions of the machine, one being a fixed part and the other one being a movable part, which move relatively each other (such as a drawer) in order to allow the capsule insertion in the machine. In this “drawer open” configuration, the movement of one of the above parts is generally obtained by driving means, such as a lever actuated by the user or driving means comprising an electric motor cooperating with gears which are functionally connected to the movable part. In this case, the “capsule holder” cannot be detached from the machine extraction head, but the two portions can be relatively moved into a drawer open position to insert the capsule between them; subsequently they are closed in order to keep the capsule inside the brewing chamber and to allow the preparation of the beverage.

In both cases, the brewing chamber comprises at least two chamber portions relatively movable each other and wherein one of this portion is provided with fluid injection means to inject the fluid into the capsule. Usually such injection means is an injection needle.

The principle of extracting and/or dissolving the contents of a closed capsule under pressure is known, and consists typically of inserting the capsule in the brewing chamber or receptacle of the machine, injecting a quantity of pressurized water into the capsule, generally after piercing a face of the capsule with the injection needle (the injection means), so to create a pressurized environment inside the capsule either to extract the substance or dissolve it, and then release the extracted substance or the dissolved substance through the capsule.

The released substance in poured into a cup or a mug located under the machine head and usually supported by a cup tray.

The machine further usually comprises a fluid tank—in most cases this fluid is water but it can be also milk—for storing the fluid that is used to dissolve and/or extract under pressure the ingredient(s) contained in the capsule. The machine also usually comprises a heating element such as a boiler or a heat exchanger, which is able to warm up the water used therein to working temperatures (classically temperatures up to 80-90° C.). In some instances the fluid can be used at a room temperature or chilled by suitable chilling means. All the means to heat or chill the fluid are considered as fluid conditioning means.

Finally, the machine comprises a pump element for circulating the water from the tank to the capsule, optionally though the heating element. The way the water circulates within the machine is e.g. selected via a selecting valve means, such as for instance a peristaltic valve.

In some instances, the machine is directly connected to a tap water of a water delivery network. The state of the art comprises many devices and methods to control the functional or operational states of a beverage preparation machine as above described. The operation states comprise for example: a machine switching-on; a closure or opening of the brewing chamber by means, for example, of the clamping means such as a lever actuated by the user; a fluid injection within the capsule or the control of a fluid feature such as its temperature or pressure. Also known are devices and methods to detect the type of capsule inserted into the brewing chamber, i.e. the ingredient contained within the capsule.

For example, EP2888182 in the name of the same Applicant discloses a capsule for a food preparation machine which has particular features to allow its identification by the machine in order to select a suitable preparation parameter (water temperature, or water pressure or volume of water to be injected within the capsule) for the food product to be prepared out of said capsule. This prior document also discloses a machine for food preparation suitable to be used with said capsule and able to automatically process the detected capsule with the correct parameters.

According to EP2888182, the capsule comprises at least one resilient portion that is deformable when said capsule is inserted into the machine cavity, and/or when said cavity is closed; the at least one resilient portion is configured to exert, upon its deformation, a counterforce onto the food preparation machine, which counterforce can be measured by a pressure sensor, the at least one resilient portion having predetermined elastic deformation properties related to the ingredient(s) contained within the capsule.

In this manner said counterforce corresponds to a predetermined ingredient within the capsule on the basis of which at least one machine operational data is selected. Therefore, on the basis of the elastic deformation properties of the capsule resilient portion, said at least one machine operational data can be coded within the capsule structure.

The prior document also teaches a food preparation system comprising the above capsule and a food preparation machine adapted to cooperate with the capsule. The machine comprises a cavity for receiving the capsule such that a food product can be prepared in the latter by injection of a fluid into said capsule. The cavity comprises a pressure sensitive portion adapted to cooperate with the capsule resilient deformable portion to transmit operational data from said capsule to said machine, said data being function of the elastic deformation properties of said resilient portion of the capsule. In this manner the machine operational data can be adapted to the particular capsule inserted into the machine, i.e. to the ingredient contained within the capsule.

The prior document specifies the meaning of the wording “deformable resilient portion”, “deformation properties” and “operational data”.

In fact, according to this prior art, by “at least one deformable resilient portion” of the capsule, it is meant that at least one part of the capsule has a shape, or is made of a material, that makes this part deformable mechanically, either elastically or plastically when a load is applied to it. This mechanical deformation of at least one portion of the capsule is caused by a mechanical load applied by the machine onto the capsule, at the time the capsule is inserted into the machine cavity, and/or at the time the machine cavity is closed to functionally enclose said capsule.

Several embodiments are described in the description of EP2888182 of said capsule deformable resilient portion: it can comprise tongues extending outwardly from a top edge of the capsule, or a deformable area of a top membrane of the capsule comprising slits or pin shaped protrusions, or curved protrusions or a ring added to the capsule body. In any case, according this prior invention, each kind of capsule containing a particular product must have its own resilient portion to be detected by the machine.

By “deformation properties”, it is clarified in the above cited prior document that each object—i.e. a resilient deformable portion of a capsule—has a specific material behavior that depends from its shape and the material that makes it. Depending on the type of material, size and geometry of each object, and the forces applied, various types of deformation may result.

Lastly, EP2888182 clarifies that, with the wording “operational data”, it is meant any data that is functionally relevant to operate the machine, that is any data that can be used by the machine electronics to set a beverage preparation parameter, for example the water temperature which is programmed in the machine electronic board for a particular product (for example coffee) to be prepared with a particular capsule, so that said electronic board actuates the water heater to heat water at a certain corresponding temperature. It should be noted that in a food or beverage preparation machine, temperatures used for the water that is mixed with a precursor ingredient to make the final food or beverage product are generally within the range of 4° C. to 100° C., preferably within the range of 12° C. to 85° C. However, most beverage preparation machines on the market use two different temperatures, depending on the type of beverage to be produced. In this case, the machine operational data that corresponds to water temperature can have the value “hot” or “cold”, depending on which type of beverage is brewed (such a value is of course coded within an machine electronic program as a digital value).

While the above cited prior document teaches an improved and simplified means to automatically prepare a beverage or food from a capsule with a food or beverage machine, the known solution requires that capsules containing different products (for example coffee or tea) must be produced with its own deformable resilient portion in order to be correctly detected by the pressure sensor of the machine. This fact has the consequence that the production costs raises and hence also the consumer has more costs to buy the capsules.

Moreover, should the above deformable resilient portion be damaged, the capsule could not be reliably processed or could not be processed at all. This can be another problem for the user. Therefore there is the need for a beverage preparation machine which is really fully automatic and wherein its operation does not depend on a particularly shaped capsule.

There is also the need for a method to control the operation of said machine in a fully automatic way without depending on the particular capsule inserted into the machine.

In general, there is the need for a beverage preparation machine that, in addition to the detection of the type of capsule or independently from this detection, can be controlled in one or more of its operational or functional states in an easy and automatic way, that is in a manner which does not require the intervention of the user, said control being obtained in a cost effective way.

### SUMMARY OF THE INVENTION

One object set out above is met with a beverage preparation machine according to the main claim.

Objects of the invention are achieved by the beverage preparation machine according to claim 1 and the method according to claim 10.

In a first aspect, there is provided a beverage preparation machine for preparing a beverage from a food substance contained in a capsule, said machine comprising:
a brewing chamber suitable to contain the capsule, said chamber being defined by at least two chamber portions relatively movable to each other, a first one of said chamber portions being provided with fluid injection means to inject a fluid into a capsule contained in the brewing chamber,
a fluid circuit connected to a fluid source, the fluid circuit providing the fluid injection means with the fluid, said fluid circuit comprising conditioning means being provided for heating or refrigerating said fluid to be injected into the brewing chamber,
clamping means being provided to apply a clamping force to said at least two chamber portions in order to close the brewing chamber,
a control unit configured to control the operation of the beverage preparation machine, wherein:
the clamping means and the at least two parts of the chamber portions are connected to a frame structure of the machine, and
said frame structure presents at least one resilient deformable portion, and
the machine comprises at last one sensor (50) for sensing a deformation of said at least one resilient deformable portion of said frame structure, and
the sensor means is connected to the control unit so that, based on the sensed deformation of said at least one deformable portion of the frame structure, the control unit carries out at least one of the following operations:
   detecting at least one of the following operations or status: a machine switching-on, a clamping means closure, a capsule presence in the brewing chamber, a fluid injection in the brewing chamber, a fluid temperature,
   detecting the type of capsule amongst a set of different capsule types.

The deformation of the frame occurs when a capsule is located within the brewing chamber and the fluid is injected into the capsule (which so deforms and pushes onto the brewing chambers portions) and/or when the clamping means are operated to close the brewing chamber. The pressure or push generated onto the brewing chamber portions or the force generated by the clamping means to close the brewing chamber define a “load” on the above cited resilient deformable portion of the frame structure which deforms this portion.

It should be noted that the wording “resilient deformable portion” means that at least one portion of the frame structure of the extraction head has a shape, or is made of a material, that makes this portion deformable mechanically, either elastically or plastically when a load (as above described) is applied to it. This mechanical deformation of at least one portion of the frame structure is caused by the mechanical load applied by the clamping means onto the extraction head frame structure portion or by the push of the capsule onto said frame structure portion when the fluid is injected in it.

The detected deformation so allows the control unit to ascertain the presence of the capsule into the brewing chamber and to switch-on the machine from a stand-by operational position. The machine extraction head frame deformation due to the injection of the fluid is also proportional to the pressure generated inside the capsule which in turn depends on the ingredient located into the capsule. In this manner, the detection of a particular deformation of the machine extraction head frame structure allows the machine control unit to detect the kind of product located into the capsule amongst a set of different capsule types so that the appropriate operational data of the machine can be selected to correctly process the capsule and prepare the beverage with the appropriate fluid temperature, volume and pressure. In fact, it should be noted that the conditioning means of the machine and a pump for the fluid are controlled by the control unit of the machine.

The control of the beverage preparation machine so occurs with a common capsule, which does not have any particular deformable feature such as those disclosed in the state of the art, for example in EP2888182.

It should also be noted that in the present document, “operational data” has the meaning above stated when the prior art EP2888182 has been discussed.

Furthermore, it should be noted that the detected deformation of the machine head frame structure is always the same and repeatable when the clamping means are operated and a capsule is inside the brewing chamber.

Moreover, the deformation of the machine extraction head frame structure generated by capsules containing the same ingredient when the fluid is injected is set to be always the same, this allowing the reliable detection of the ingredient inside the capsules and the correct operational data of the machine to be selected for preparing the corresponding beverage. The sensor means are always connected to a frame structure portion of the machine extraction head and also detect the deformation of this portion when the clamping means are operated. This allows the detection of the capsule within the brewing chamber in an easy and quick way. Preferably, the sensor means for sensing the deformation of the resilient deformable portion of the frame structure are a strain gauge or a piezoelectric force sensor. This sensor is a common device, having low costs which do not affect the total costs of the beverage preparation machine. The sensor means can also be located close to the portion of the brewing chamber supporting the injection means. This permits a direct and immediate detection of the deformation of the frame structure due to the build-up of pressure within the capsule.

Preferably, a maximum deformation value of the deformable portion of the frame structure is allowed in order to detect a possible capsule blocked in the brewing chamber.

Lastly, the control unit has a memory unit wherein data of different deformation values of the deformable portion of the machine head frame structure are stored and are linked to operational data of the machine and/or to different types of ingredient capsule amongst a set of different capsule types, said stored data also comprising a deformation value corresponding to the clamping means closure. This feature allows a correct control of the operation if the machine to be obtained.

According to various preferred embodiments:
the sensor means is at least one deformation sensor.
the deformation sensor can be a strain gauge based sensor or a piezoelectric force sensor.
the at one resilient deformable portion of the frame structure can be a side portion of said frame structure, the sensor means being directly connected with the machine control unit.
the at least one resilient deformable portion of frame structure can be a fixed portion of the brewing chamber.
the at least one resilient deformable portion of the frame structure can be a portion close to the first chamber portion of the brewing chamber.
the control unit can be connected with a memory unit containing operational data of the beverage preparation machine related to deformation of the resilient deformable portion of the frame structure of the extraction head and/or data relating to different types of capsule configured to be located within the brewing chamber.
a plurality of deformation sensors can be provided attached to corresponding resilient deformation portions of the frame structure.
the sensors can be electrically connected so as to form a Wheatstone bridge.

In a second aspect, there is provided method to control at least one operation phase of the above beverage preparation machine, wherein a deformation of at least one resilient deformable portion of the frame structure is detected by the control unit during the movement of the clamping means and/or during the injection of the fluid within the capsule, and wherein based on the detected deformation of said at least one deformable portion, said control unit carries at least one of the following operations:
detecting at least one of the following operations or status: a machine switching-on, a clamping means closure, a capsule presence in the brewing chamber, a fluid injection in the brewing chamber, a fluid temperature,
detecting the type of capsule amongst a set of different capsule types.

In one embodiment, the detection of the deformation of the at least one resilient deformable portion is sensed by at least one deformation sensor connected with the corresponding resilient deformable portion and, the sensed deformation is processed by the control unit by comparing said sensed deformation to pre-set deformation values.

In one embodiment, the pre-set deformation values can be stored in a memory unit connected with the control unit, each stored deformation value corresponding to operational data of the beverage preparation machine and/or to data relating to a type of capsule amongst a set of different capsule types able to be located within the brewing chamber.

In one embodiment, the control unit is able to detect the progress of the beverage preparation during the fluid injection within the capsule by continuously detecting the deformation of the at least one resilient deformable portion, said control unit continuously comparing the sensed deformation with a pre-set deformation value, and when the deformation becomes less than said pre-set value, the control unit is configured to stop the fluid injection within the capsule.

In one embodiment, the control unit can continuously adjust the pressure and/or volume of the injected fluid or liquid within the capsule according to the continuously sensed deformation value of the frame structure portion and through its comparison to corresponding stored operational data.

In one embodiment, the control unit can be configured to transmit the sensed deformations of the at least one deformable portion of the frame structure and/or the detected operations and status or types of capsules to a remote server.

### BRIEF DESCRIPTION OF THE DRAWINGS

Additional features and advantages of the present invention are described in, and will be apparent from, the description of the presently preferred embodiments which are set out below with reference to the drawings in which:

FIG. 1 is a perspective general view of an example of a beverage preparation machine comprising a capsule holder;

FIG. 2 shows in side view the beverage preparation machine of FIG. 1, the machine being represented with a cut portion to show some inner components;

FIG. 3 is a perspective view of a capsule holder during its insertion into a portion of a beverage machine extraction head;

FIG. 4 is a partial cross-section view taken along line 4-4 of FIG. 3;

FIGS. 5-7 are perspective schematic views from different positions of the frame of the portion of the machine head suitable to house the capsule holder, not shown, of FIG. 3, and showing the forces which generate during the use of the beverage machine;

FIG. 8 is a schematic view of a diagram showing internal components of the beverage preparation machine according to the present invention;

FIGS. 9-10 are perspective views of another type of a beverage preparation machine according to another embodiment of the invention;

FIGS. 11-12 are respectively, a perspective view and a side view, with a partly cut portion, of another type of a beverage preparation machine according to another embodiment of the invention; and

FIG. 13 is a schematic view of an electric circuit used in a machine according to the present invention.

### DETAILED DESCRIPTION OF THE INVENTION

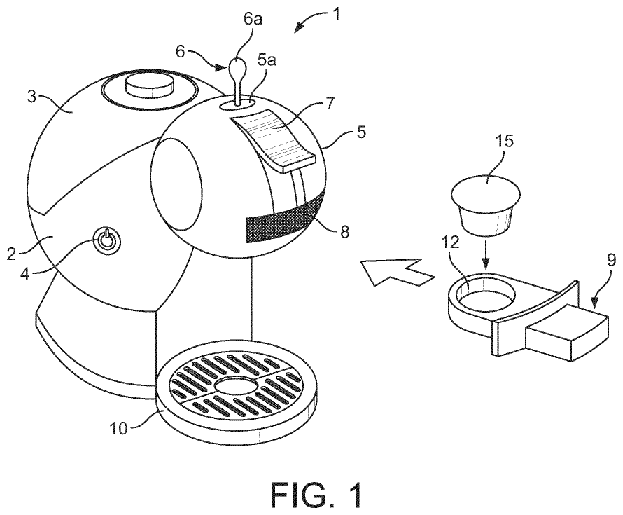

FIG. 1 shows a beverage preparation machine 1 comprising a machine body 2, and a fluid source such as a water reservoir or tank 3 that can be removed from the machine body 2 for refill. The body 2 comprises an on/off push button 4. The fluid source or reservoir 3 is connected to a fluid circuit 300 providing fluid to a brewing chamber of an extraction head 5. In general the fluid can be conditioned, i. e. heated or chilled or provided to head 5 at a room temperature. In the present description only the heating of the fluid will be described; in any case, the head 5 comprises a water temperature selector 6 for hot or ambient temperature water, a locking lever 7, and an opening 8 for insertion of a capsule holder 9.

The capsule holder, in the embodiment of this figure, is completely removably connected to the extraction head 5 and comprises a seat 12 for a capsule 13. The capsule holder is shown in a schematic way because it is known per se. It can be shaped in different ways, but it always has the above described features.

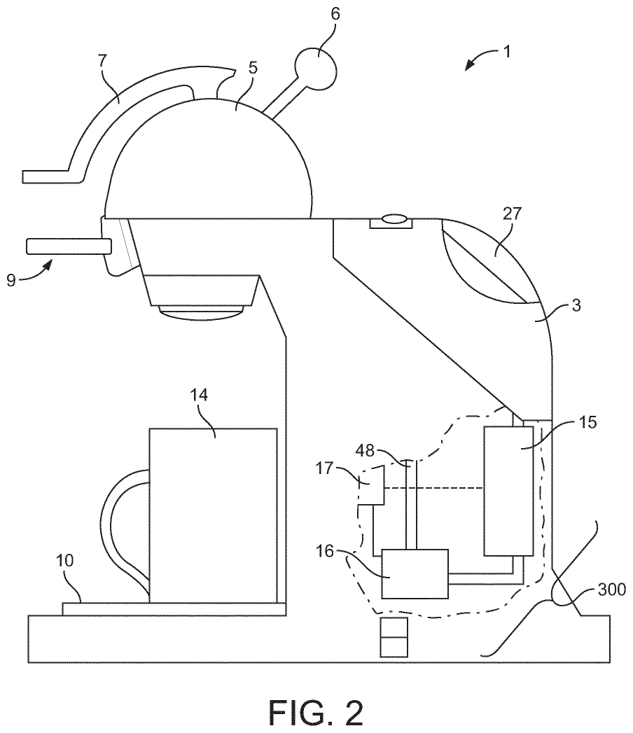

The machine 1 further comprises a cup tray 10, for supporting a cup 14 under the extraction head when the beverage is poured from the capsule (see FIG. 2).

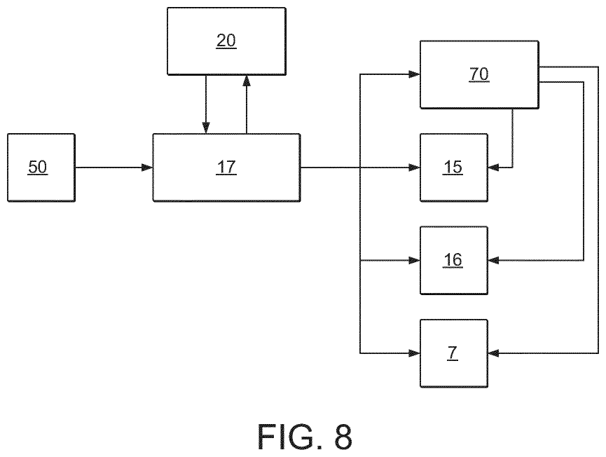

FIG. 2 shows the beverage preparation machine of FIG. 1 with its inner components or functional members. The machine body 2 comprises, in the fluid circuit, at least a boiler 15, a pump 16 and a control unit 17 which controls the operation of the machine 1 and its components to which it is connected; this unit 17 has a memory unit 20 (see FIG. 8) containing data relating to temperature, volume and pressure of the fluid (typically water) used to prepare a beverage by injecting said fluid into the capsule as will be explained further in the following. Said data of temperature, pressure and volume of the fluid represent the operational data of the machine 1 and depend on the type of ingredient contained within the capsule.

The control unit 17 is also connected to a known component 18 of the machine which allows the latter to be pre-heated after the operation of on/off push button 4.

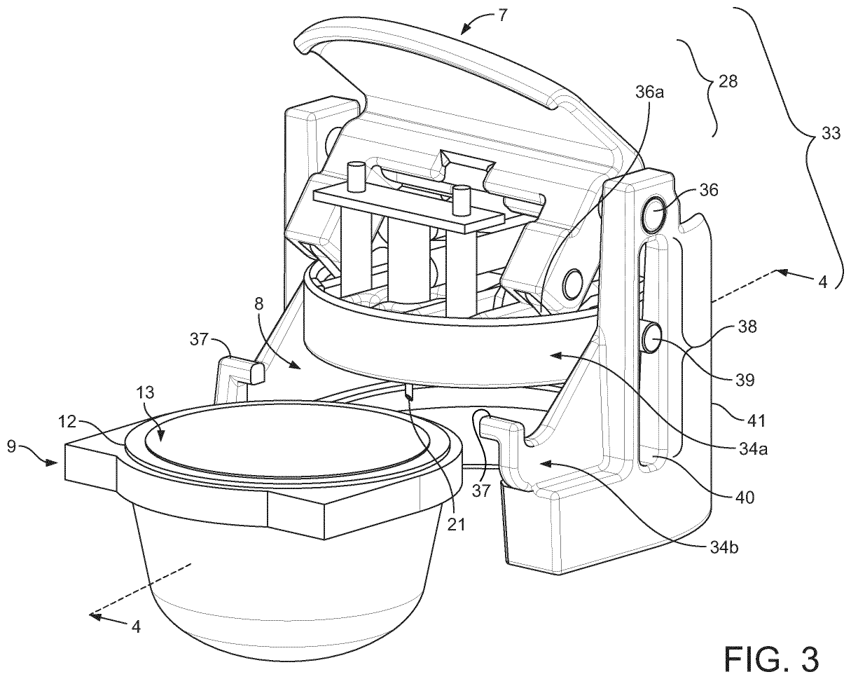

The tank 3 is provided in order to supply liquid such as water to the boiler 15 and the pump 16, and hence to the machine extraction head 5 of the beverage preparation machine 1. Inside the extraction head 5, an injection element or needle 21 (shown in FIGS. 3, 4, 6 and 7) is provided and this injection needle is connected to the pump 16. During the use of the machine 1, the capsule 13 is pierced in a known way by the injection element 21 and the capsule can be effectively provided with liquid and a beverage can be prepared from the ingredients within the capsule 13.

The reservoir 3 is preferably provided with a handhold 27 for facilitating the handling of the reservoir 3. Thus a user can handle the reservoir 3 in a convenient way. An outlet (not shown) which is preferably situated at the bottom of the reservoir 3 enables a connection between the reservoir 3 and the fluid circuit 300 of the machine 1.

As above described, the extraction head 5 comprises the locking lever 7 connected to a closing mechanism 28 (per se known and shown in FIG. 3) for selectively enclosing the capsule 13 in the extraction head 5. Head 5 also comprises the water temperature selector 6 which is a control lever 6A to selectively supply either cold (at room temperature) or hot water to the extraction head 5 and hence to the capsule 13. The control lever 6A is connected at least to the control unit 17 of the machine 1. Hence, the control lever 6A may be switched-on from a neutral position to a first position choosing hot water or to a second position choosing cold water by moving the control lever 6A to the left or to the right (or vice-versa) when seen in front-rear direction of the machine 1. Accordingly, a user can choose whether to provide cold or hot water to the capsule 13 within the extraction head 5 in order to prepare a cold or hot beverage. For enabling the movement of the control lever 6A the extraction head 5 is provided with a groove 5A.

FIGS. 3-7 shows a preferred embodiment of the inside of the extraction head 5 of the machine 1. The exaction head has a frame structure 33 comprising the opening 8 for the insertion of the capsule holder 9. The frame structure 33 has two enclosing members 34a, 34b that are provided in order to enclose the capsule 13 within a brewing chamber 35 of the extraction head 5. In the present embodiment, the brewing chamber comprises said enclosing members 34a, 34b and the seat 12 of the capsule holder. The capsule 13 is thus enclosed by the seat 12, a first, upper enclosing member 34a and a second, lower enclosing member 34b. The first enclosing member 34a supports the injection needle 21.

In this preferred embodiment, said second enclosing member 34b is defined by guiding means 37 provided within the opening 8 of the extraction head 5 in order to keep the capsule holder 9 inserted into the opening 8 at a fixed position within the extraction head 5.

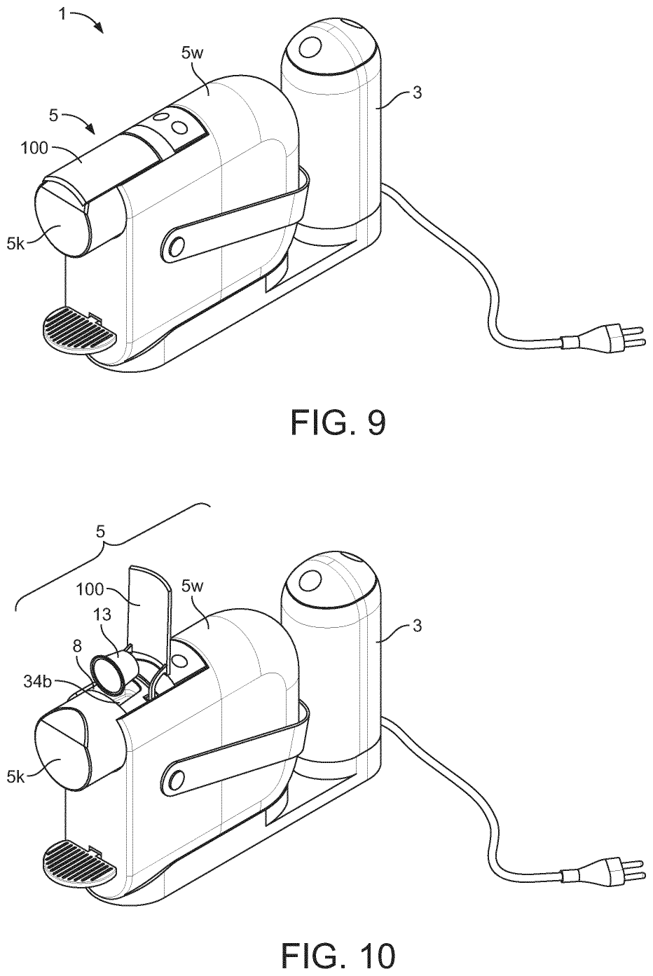

In another preferred embodiment such as the one shown in FIGS. 9 and 10 (where parts corresponding to those of FIGS. 1-8 have the same reference numbers), the capsule 13 is directly inserted into the opening 8 by hand, the second enclosing member 34b may be designed as guiding means for directly receiving the capsule 13 provided by a user. This other embodiment of the invention relates to a known machine 1 comprising an extraction head 5 including two portions 5K and 5W which are relatively movable in a sliding way such as a drawer; a first portion 5W is fixed, while the second portion 5K is movable on known guides (not shown) when the two portions are separated. When the above portions are separated, the opening 8 is provided between them and the capsule 13 can be inserted in the extraction head 5. A cover 100 can be provided to cover opening 8.

The brewing chamber 35 is defined by said portions 5W and 5K, the second enclosing member 34b being part of the movable portion, the first enclosing member 34a being the fixed portion 5W.

When the beverage preparation machine 1 is used and the capsule has been inserted into the opening 8, the two portions 5K and 5W are relatively moved one towards the other (by means of known driving means comprising an electric motor and connected gear or a manually operated handle) in order to close the capsule in the brewing chamber.

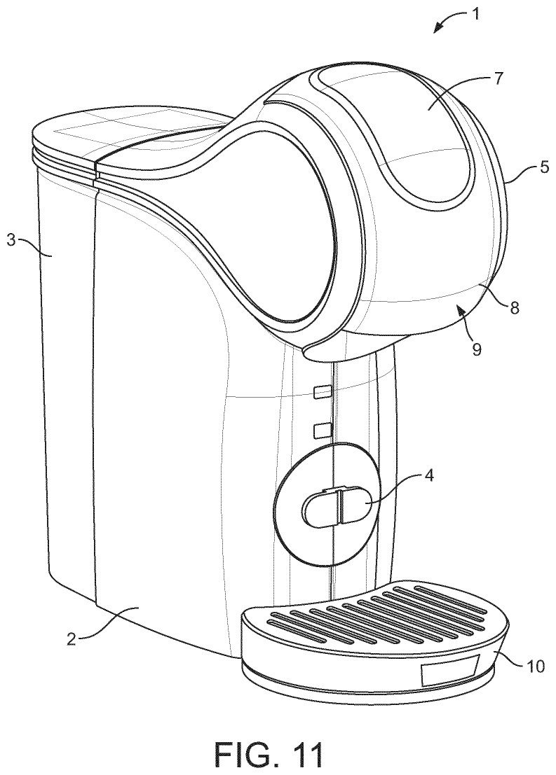

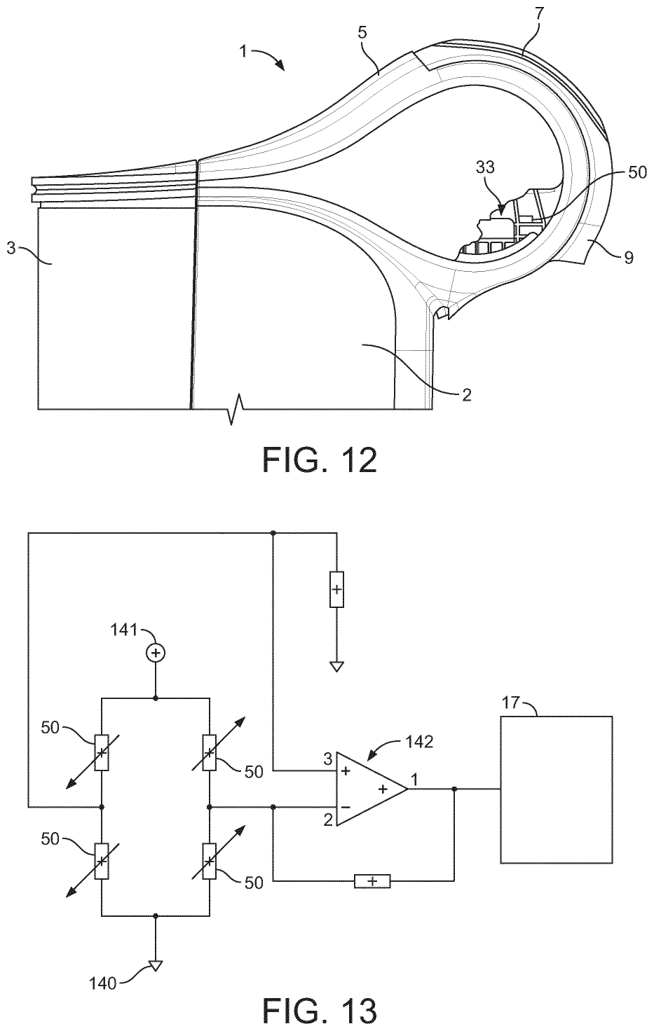

A further embodiment of the present invention is shown in FIGS. 11 and 12. In the latter, where portions or parts corresponding to those of the already disclosed Figures have the same reference numbers, the beverage preparation machine is very similar to the machine shown in FIG. 1; the only differences are in the shape of the machine body 2 and of the tank 3. Other portions (such as lever 7) of the machine in FIGS. 11 and 12 have different shapes if compared to the corresponding portions of FIG. 1, but their use and functions are the same. Returning to the embodiment shown in FIGS. 1-8, the first, upper enclosing member 34a is connected to the closing mechanism 28 in order to enable a relative movement of the two enclosing members 34a, 34b. Thus, the second, lower enclosing member 34b is situated at a fixed position within the opening 8 of the extraction head 5, whereas the first, upper enclosing member 34a can be moved relatively to the second enclosing member 34b. Preferably, the first enclosing member 34a can be lowered or lifted in order to approach or separate the two enclosing members 34a, 34b.

Said enclosing members 34a, 34b are designed for being transferred between an open insertion position in which a capsule 13 or the capsule holder 9 housing said capsule 13 may be inserted into the brewing chamber 35 of the device, and a closed injection position in which the capsule 13 is enclosed and pierced by the injection element 21 (or needle element) which is provided at the movable enclosing member 34a. Thereby, as above stated, the brewing chamber is defined by the first enclosing member 34a which is the upper enclosing member and the second, lower enclosing member 34b in combination with the capsule seat 12 of the capsule holder 9.

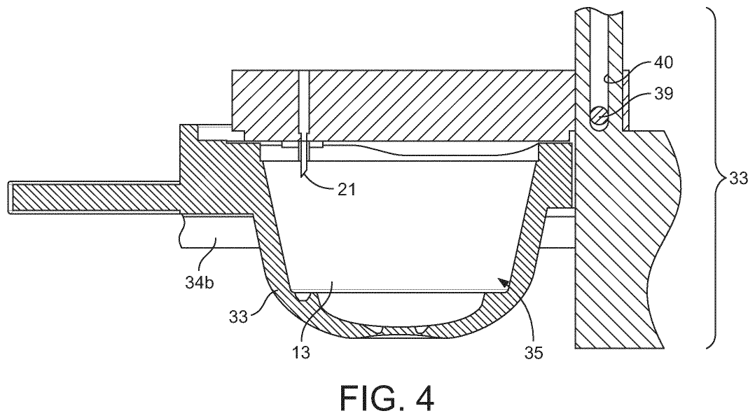

As shown in FIG. 4, the closing mechanism 28 is in a closed state in which the upper enclosing member 34a connected to the closing mechanism 28 is in its lowered injection position. Hence, the needle element 21 provided at the enclosing member 34a is enabled to pierce the capsule 13 which is housed in the seat 12 of the capsule holder 9.

In order to enable a relative movement of the enclosing member 34a, 34b, the closing mechanism 28 connected to the enclosing member 34a comprises (see FIG. 3) pivoting means 36, 36A, sliding means 38 (pins 39 moving in fixed guides 40 at each side of enclosing member 34a) and the locking lever 7 to operate the closing mechanism 1. The sliding means 38 are preferably situated close to a back wall 41 of the brewing chamber 35. The closing mechanism 1 is preferably a knee lever closing mechanism. Of course, any other closing or transmission mechanism may be connected to at least one of the enclosing members 34a, 34b in order to enable a relative movement of them. The closing mechanism is per se known and therefore it will be not described further.

During the use of the beverage preparation machine 1, as the pump 16 provides liquid to a pipe 48 connected to the injection or needle element 21 and thus to the capsule 13 beneath the injection member, the liquid is made to interact with the ingredients provided within the capsule 13. In addition, pressure is built-up within the capsule 13 due to the liquid introduced by the needle element 11. In a known manner, the capsule is opened and the beverage is poured from the capsule downwardly via a known capsule outlet (not shown). The beverage is so received by the cup 14.

The present invention may as well apply to any other food or beverage cartridge, pod or sachet containing ingredient(s) brewed, dissolved or diluted in a beverage device. In the context of the invention, the term “capsule” is used to encompass such cartridge, pod or sachet using these other brewing principles.

According to an aspect of the present invention, the frame structure 33 of the machine extraction head 5 is provided with sensor means 50 for sensing any deformation of said structure when a load is applied to it, that is when the locking lever is closed and/or when the fluid is injected into the capsule, as above described. The sensor means 50 is connected to the control unit 17 and allows the latter to detect at least one of the following status or operations:
the presence of the capsule in the extraction head 5;
the machine switch-on;
a correct closure of the locking lever so that the injection of fluid into the capsule can be done without any risk of fluid leakage from the brewing chamber;
the operational parameter of the machine.

Furthermore, the connection of the sensor means 50 to the control unit 17 enables this unit to detect the type of ingredient contained within the capsule (or to detect the type of ingredient capsule) amongst a set of different capsule types.

Therefore the control unit can automatically control the operation of the beverage preparation machine on the basis of the sensed deformation of said frame structure.

More in particular, the sensor means can be at least one sensor chosen among any sensor suitable to detect a deformation of a resilient deformable portion of the frame structure 33; such sensor can be a strain gauge based sensor which modifies its electric resistance when deformed or a piezoelectric force sensor which generates an electrical charge (that can be measured) when a force (such a deformation force) is applied on it.

It should be noted that as above stated in this description, by “resilient deformable portion” of the frame structure of the machine extraction head it is meant that at least one part of said structure has a shape or is in a material that make this portion deformable mechanically either elastically or plastically when a load (as above explained) is applied to it. This load deforms, for example it bends, the above cited frame structure portion when the user interacts with the machine (for example by moving the locking lever 7) to close the capsule in the brewing chamber and/or a beverage is prepared and/or an hydraulic load (pressure) is applied to the inside of the capsule.

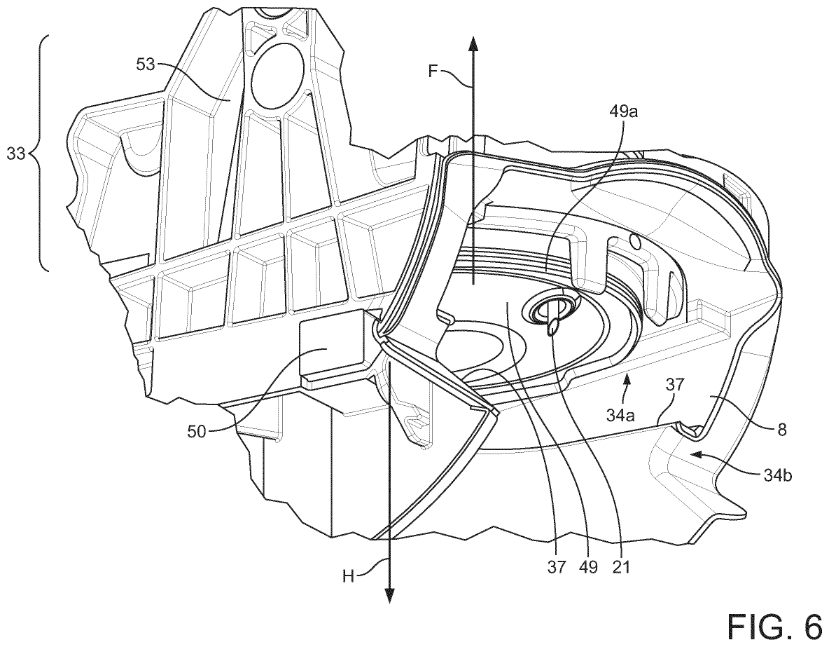

In a first embodiment, at least one sensor 50 is fixed to a side portion 53 of frame structure 33 (see FIGS. 6, 7 and 12) and is directly connected to control unit 17.

In a second embodiment, the sensor means or simply at least one sensor 50 is located close to the upper enclosing member 34a of the frame structure of the extraction head.

In a third embodiment, the sensor 50 is connected to the lower enclosing member 34b and is directly connected to the control unit 17.

Obviously more sensors 50 may be provided and may be simultaneously connected to the side portion 53 or be located close to at least one of the engagement portions 34a, 34b in order to obtain more deformation data which can be combined to obtain a more precise evaluation of the induced deformation value.

FIG. 13 shows an example of an electric circuit containing a plurality of sensors 50, for example four strain gauges, connected to the control unit 17. The strain gauges are independent each other and are attached to the different portions of the frame structure 33 in such a way that they are exposed to the maximum deformation exhibited by the frame structure during a beverage preparation.

As shown in the FIG. 13, the four sensors 50 are so connected to form a Wheatstone bridge which is grounded at 140 and receives a positive voltage at 141. The bridge is connected to an amplifier 142 having the positive input connected to ground; the output of the amplifier is connected to the control unit 17.

Obviously, should less sensors 50 be used, a suitable connection to the control unit will be made in order to allow the latter to detect the deformation of the corresponding portion(s) of the frame structure 33. This connection can be obtained according the common knowledge of the skilled person and will not be described in more detail.

The operation of sensor means 50 will be described below.

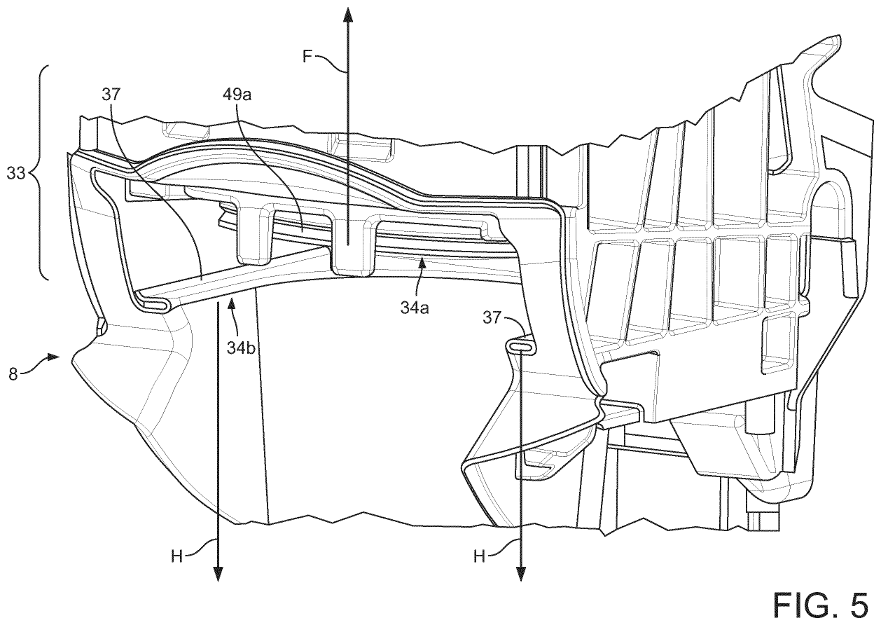

As above described, when the fluid is injected into the capsule, the pressure builds-up within the capsule and the latter applies forces on the enclosing members 34a, 34b of the brewing chamber (see arrows F and H in FIGS. 5 and 6). It should be noted that the brewing chamber is sealed by means of sealing means defined by a yielding surface 49 of the upper enclosing member 34a suitable to contact the capsule 13 and by a protruding edge 49A of said surface 49 suitable to cooperate with a corresponding groove formed around the capsule 13 within the capsule holder 9 when said capsule is in the capsule holder; the sealing means operate between the capsule holder 9 and the upper enclosing member 34a so that the pressure build-up is maintained.

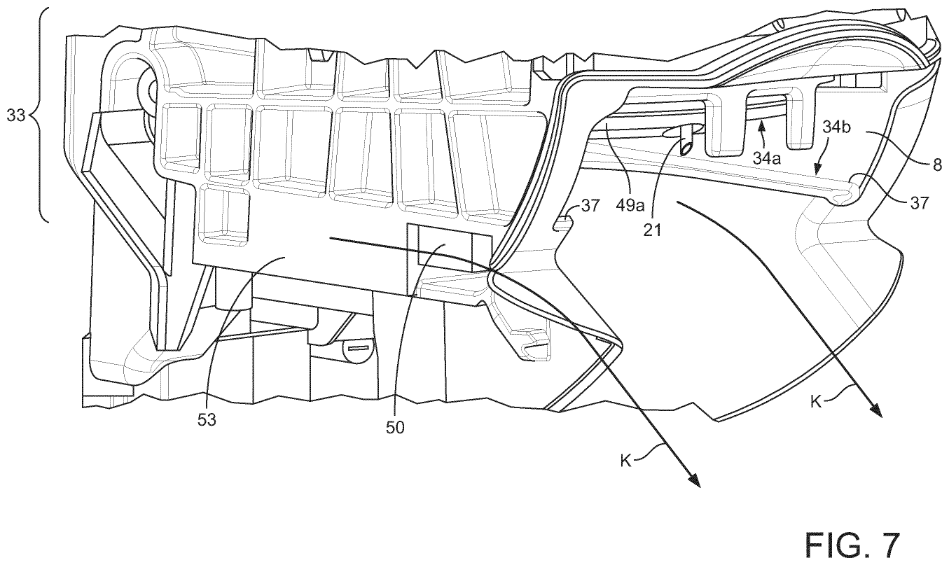

Consequently, the above forces create a bending force on the frame portion 33, for example on the side portion 53 of the frame structure 50 of the extraction head 5 (see arrows K in FIG. 7). The bending force resiliently deforms the above cited member 34a and/or 34b and/or the side portion 55 (for example moving it in a range of 0.5 to 2 mm from a rest position), and this is detected by sensor 50. The sensor generates an electric signal which is processed by the control unit 17 that can so detect the pressure value within the capsule. On the basis of data stored in the memory unit 20 that, for example, link the pressure values to a set of different capsule types e.g. to different products inside the capsules, the control unit can detect what product is contained within the capsule and adjust the operational parameters of the machine accordingly. For example, if roasted and ground coffee is detected, the control unit will adjust the pressure and temperature of the fluid during its injection into the capsule at about 2 to 12 bar.

In the same time, the continuous detection of the bending force by sensor 50 allows the beverage production process to be controlled by the control unit 17 in a very precise way: when the detected force is less than a pre-set value (stored in the memory unit 22) because a beverage has been poured from the capsule, then the control unit stops the fluid injection in the capsule (stopping the pump 16). In this manner the volume and/or pressure of liquid injected within the capsule during the process of beverage preparation may also be continuously adjusted according to the continuously detected variable bending force (caused by the progress of the beverage preparation).

In particular, the control unit 17 is able to detect the progress of the beverage preparation during the fluid injection within the capsule 13 by continuously detecting the deformation value of the resilient deformable portion 53 of the extraction head 5 of the machine through the sensor 50, said control unit continuously comparing the sensed deformation value with the values stored in the memory unit 20 and if the deformation value is less than a set value, then the control unit stops said fluid injection within the capsule.

In case of the control of fluid injection, the control unit 17 continuously adjusts the pressure and/or volume of the injected fluid or liquid within the capsule 13 according to the continuously sensed (by sensor 50) deformation value of frame structure portion 53 and through its comparison to corresponding operational data stored in the memory unit.

According another embodiment, the sensor means allow the presence of a capsule to be detected with the simple closure movement of the locking lever 7 (or of the movable portion 5K of the extraction head 5 in the embodiment of FIGS. 9 and 10). In fact, if a capsule is within the brewing chamber, the capsule opposes to said movement and generates the above cited forces against the frame structure of the extraction head 5 which bends and the bending is detected through the sensor 50 by the control unit 17. In this case the control unit may switch-on a known pre-heating device 70 such as a thermoblock or similar water heating system of the machine (see FIG. 8) which, for example, exits from a stand-by phase power saving mode.

In a further embodiment, in the above case of detection of the capsule by means of the locking lever movement, the control unit switches-on the machine from a completely deactivated phase. Lastly, with the use of the above cited sensor 50 it is possible to detect a change in the operational feature of the machine caused by its continuous use: for example, a less deformation of the frame structure than that was expected during the fluid injection could mean that the injector element in clogged by the limestone so that the fluid pressure inside the capsule is not the expected one; therefore a service is needed. A warning can be generated through visual warning means (for example, one or more LEDs) located on the head 5. Or the above situation could be due to a problem to the pump, for which a full service intervention is due.

A change in the detection of the frame structure deformation could also be the reason of aging of the machine.

Furthermore, when the control unit is connected to a remote server, for example through connection to Internet, the detected operations, status or types of capsules introduced in the brewing chamber can be sent to the machine manufacturer for remote monitoring purpose of the machine, for example to continuously keep the possible reliability of the machine under control. The data can also be used to detect how many and which capsules are used by the users for marketing trends or capsules manufacturing purposes.

In this embodiment either the sensed deformations of the at least one deformable portion of the frame structure can be transmitted as such and analysed remotely at the server and/or the detected operations and status or types of capsules, such as identified locally, can be sent to the remote server.

The present invention can be applied to any kind of beverage preparation machine which uses common capsules. No particular capsule is necessary to be used to implement the present invention. This is a real advantage for the machine manufacturer, the capsule producers and the users.

It should be understood that various changes and modifications to the presently preferred embodiments described herein will be apparent to those skilled in the art. Such changes and modifications can be made without departing from the scope of the present invention and without diminishing its attendant advantages. It is therefore intended that such changes and modifications be covered by the appended claims.

1. A beverage preparation machine for preparing a beverage from a food substance contained in a capsule, said machine comprising:
a brewing chamber suitable to contain the capsule, said chamber being defined by at least two chamber portions relatively movable to each other, a first one of said chamber portions being provided with a fluid injection member to inject a fluid into a capsule contained in the brewing chamber,
a fluid circuit connected to a fluid source, the fluid circuit providing the fluid injection member with the fluid, said fluid circuit comprising a conditioner being provided for heating or refrigerating said fluid to be injected into the brewing chamber,
a clamp being provided to apply a clamping force to said at least two chamber portions in order to close the brewing chamber,
a control unit configured to control the operation of the beverage preparation machine,
wherein:
the clamp and the at least two parts of the chamber portions are connected to a frame structure of the machine, and
said frame structure presents at least one resilient deformable portion, and
the machine comprises at last one sensor for sensing a deformation of said at least one resilient deformable portion of said frame structure, and
the sensor is connected to the control unit so that, based on the sensed deformation of said at least one deformable portion of the frame structure, the control unit carries out at least one of the following operations:
detecting at least one of the following operations or status: a machine switching-on, a clamping closure, a capsule presence in the brewing chamber, a fluid injection in the brewing chamber, a fluid temperature, and
detecting the type of capsule amongst a set of different capsule types.

2. The machine according to claim 1, wherein the sensor is at least one deformation sensor.

3. The machine according to claim 2, wherein the deformation sensor is a strain gauge based sensor or a piezoelectric force sensor.

4. The machine according to claim 1, wherein the at one resilient deformable portion of the frame structure is a side portion of said frame structure, the sensor means being directly connected with the machine control unit.

5. The machine according to claim 1, wherein the at least one resilient deformable portion of frame structure is a fixed portion of the brewing chamber.

6. The machine according to claim 1, wherein the at least one resilient deformable portion of the frame structure is a portion close to the first chamber portion of the brewing chamber.

7. The machine according to claim 1, wherein the control unit is connected with a memory unit containing operational data of the beverage preparation machine related to deformation of the resilient deformable portion of the frame structure of the extraction head and/or data relating to different types of capsule configured to be located within the brewing chamber.

8. The machine according to claim 2, wherein a plurality of deformation sensors is provided attached to corresponding resilient deformation portions of the frame structure.

9. The machine according to claim 8, wherein the sensors are electrically connected so as to form a Wheatstone bridge.

10. A method to control at least one operation phase of a beverage preparation machine, wherein a deformation of at least one resilient deformable portion of a frame structure is detected by the control unit during the movement of a clamp and/or during the injection of fluid within capsule, and
wherein based on the detected deformation of said at least one deformable portion, said control unit carries at least one of the following operations:
detecting at least one of the following operations or status: a machine switching-on, a clamping closure, a capsule presence in the brewing chamber, a fluid injection in the brewing chamber, a fluid temperature, and
detecting the type of capsule amongst a set of different capsule types.

11. Method according to claim 10, wherein the detection of the deformation of the at least one resilient deformable portion is sensed by at least one deformation sensor connected with the corresponding resilient deformable portion and, the sensed deformation is processed by the control unit by comparing said sensed deformation to pre-set deformation values.

12. Method according to claim 11, wherein the pre-set deformation values are stored in a memory unit connected with the control unit, each stored deformation value corresponding to operational data of the beverage preparation machine and/or to data relating to a type of capsule amongst a set of different capsule types able to be located within the brewing chamber.

13. Method according to claim 12, wherein the control unit is able to detect the progress of the beverage preparation during the fluid injection within the capsule by continuously detecting the deformation of the at least one resilient deformable portion, said control unit continuously comparing the sensed deformation with a pre-set deformation value, and when the deformation becomes less than said pre-set value, the control unit is configured to stop the fluid injection within the capsule.

14. Method according to claim 13, wherein the control unit continuously adjusts the pressure and/or volume of the injected fluid or liquid within the capsule according to the continuously sensed deformation value of the frame structure portion and through its comparison to corresponding stored operational data.

15. Method according to claim 10, wherein the control unit is configured to transmit the sensed deformations of the at least one deformable portion of the frame structure and/or the detected operations and status or types of capsules to a remote server.
